(19) United States
(12) Patent Application Publication
(10) Pub. No.: US 2006/0121187 A1
(43) Pub. Date: Jun. 8, 2006

(54) Vacuum cold spray process

(76) Inventors: Jeffrey D. Haynes, Stuart, FL (US); Douglas Alan Hobbs, Jupiter, FL (US)

Correspondence Address: BACHMAN & LAPOINTE, P.C., 900 CHAPEL STREET, SUITE 1201, NEW HAVEN, CT, 06510, US

(21) Appl. No.: 11/003,137

(22) Filed: Dec. 3, 2004

(51) Int. Cl. B05D 1/12; B05C 5/00; B05D 1/08

(52) U.S. Cl. 427/180; 427/446; 118/300

(57) ABSTRACT

A method for depositing a metallic material onto a substrate comprises the steps of placing the substrate in a vacuum chamber, inserting a spray gun nozzle into a port of the vacuum chamber, and depositing a powdered metallic material onto a surface of the substrate without melting the powdered metal material. The depositing step comprises accelerating particles of the powdered metal materials within the vacuum chamber to a velocity so that upon impact the particles plastically deform and bond to a surface of the substrate.

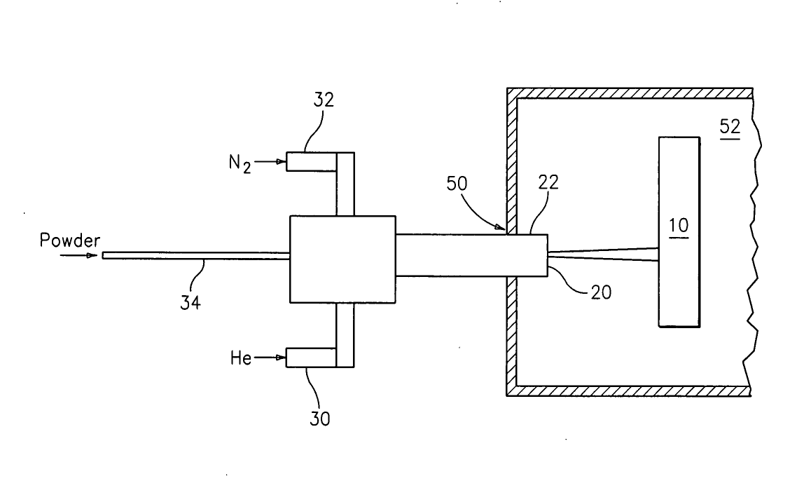

### BACKGROUND OF THE INVENTION

(1) Field of the Invention

The present invention relates to a method for depositing metal alloys onto a substrate

(2) Prior Art

Cold gas dynamic spraying or “cold spray” has been recently introduced as a new metallization spray technology. The cold gas spray process which has been introduced is an open-air process that uses a gas such as helium to accelerate the metallic particles. Part of the advantage to cold spray is that no oxygen is picked up during deposition, even in open-air, since particles are not melted and are contained within a helium gas stream.

There is some concern that in multiple pass coatings, there may be debonded regions between the initial and subsequent passes. Some believe that once the initial pass is deposited, and the spray gun moves off that location, the outer layer of the deposited material oxidizes and the subsequent pass does not sufficiently blast or otherwise remove this oxidation and therefore, a poor bond interface results.

The debonding issue needs to be overcome if cold spray is to compete with other processes for low “buy-to-fly” ratio technologies, or additive technologies such as laser engineered net shape.

### SUMMARY OF THE INVENTION

Accordingly, it is an object of the present invention to provide a method for forming one or more deposited layers on a substrate using cold spray which avoids oxidation of an outermost deposited layer during deposition.

It is a further object of the present invention to provide a method as above which avoids debonding when multiple layers are deposited.

It is still a further object of the present invention to provide an improved system for depositing metallic materials onto a substrate.

The foregoing objects are attained by the method of the present invention.

In accordance with the present invention, a method for depositing a metallic material onto a substrate broadly comprises the steps of placing the substrate in a vacuum chamber, inserting a spray gun nozzle into a port of the vacuum chamber, and depositing a powdered metallic material onto a surface of the substrate without melting the powdered metal material. The depositing step comprises accelerating particles of the powdered metal materials within the vacuum chamber to a velocity so that upon impact the particles plastically deform and bond to a surface of the substrate.

Further in accordance with the present invention, a system for depositing a metallic material onto a substrate broadly comprises a vacuum chamber in which the substrate is positioned, and means for depositing a powdered metallic material onto a surface of the substrate without melting the powdered metal material. The depositing means includes a spray gun nozzle positioned within a port of the vacuum chamber.

Other details of the vacuum cold spray process, as well as other objects and advantages attendant thereto, are set forth in the following detailed description and the accompanying drawings wherein like reference numerals depict like elements.

### BRIEF DESCRIPTION OF THE DRAWINGS

The FIGURE illustrates a system for depositing metallic material on a substrate in accordance with the present invention.

### DETAILED DESCRIPTION OF THE PREFERRED EMBODIMENT(S)

As pointed out above, in the past few years, a technique known as cold gas dynamic spraying (“cold spray”) has been developed. This technique is advantageous in that it provides sufficient energy to accelerate particles to high enough velocities such that, upon impact, the particles plastically deform and bond to the surface of the component on which they are being deposited so as to build a relatively dense coating or structural deposit. Cold spray does not metallurgically transform the particles from their solid state. The cold spray process therefore has great utility in a variety of processes where it is necessary to deposit metallic material onto a substrate.

Referring now to the FIGURE, there is shown a system for forming a deposit of metallic material on a substrate. The system includes a spray gun 22 having a converging/diverging nozzle 20 through which the repair material is sprayed onto a surface 24 of the substrate 10. The substrate 10 may be held stationary or it may be rotated by any suitable means (not shown) known in the art.

The spray gun nozzle 20 is inserted into a port 50 of a vacuum chamber 52 in which the substrate 10 is located in order to seal it from potential oxidation. Even if the gas which is injected into the chamber 52 via the nozzle 20 overcomes the initial vacuum pressure, it will not matter if the gas is an inert gas such as helium, nitrogen, or mixtures thereof. Using the system of the present invention, one can apply the material to the substrate 10 in multiple passes without any oxidation occurring between deposition passes. One advantage to the system of the present invention is that the gas which is used could be easily recovered through the vacuum system, compressed and recycled. This is particularly advantageous for helium which costs 12 times the cost of nitrogen.

Still another advantage to using the vacuum chamber 52 is that particle velocities can be increased beyond those obtainable in an open-air system. If particle velocity is increased, the coating quality increases due to improved density and adhesion.

In the method of the present invention, the metal material feedstock may be a powdered metal material such as a powdered metal alloy. The powdered metal material may be the same alloy as that forming the substrate or it may be an alloy material compatible with the material forming the substrate 10. For example, the powder metal material may be a powdered nickel base superalloy, such as IN 718, IN 625, IN 100, WASPALOY, IN 939, and GATORIZED WASPALOY, or a powdered copper base alloy such as GRCop-84. The powdered metal material particles that are used to form the deposit on the surface 24 of the substrate 10 preferably have a diameter in the range of 5 microns to 50 microns. Smaller particle sizes such as those mentioned before enable the achievement of higher particle velocities. Below 5 microns in diameter, the particles risk getting swept away from the surface 24 due to a bow shock layer above the surface 24. This is due to insufficient mass to propel through the bow shock. The narrower the particle size distribution, the better the velocity is. This is because if one has large and small particles (bi-modal), the small ones will hit the slower, larger ones and effectively reduce the velocity of both.

The fine particles of the material to be deposited may be accelerated to supersonic velocities using compressed gas, such as helium, nitrogen, other inert gases, and mixtures thereof. Helium is a preferred gas due to its low molecular weight and because it produces the highest velocity at the highest gas cost.

The bonding mechanism employed by the method of the present invention for transforming the powdered material into a deposit is strictly solid state, meaning that the particles plastically deform. Any oxide layer that is formed on the particles is broken up and fresh metal-to-metal contact is made at very high pressures.

The powdered metal material used to form the deposit may be fed to the spray gun 22 using any suitable means known in the art, such as modified thermal spray feeders. One custom designed feeder that may be used is manufactured by Powder Feed Dynamics of Cleveland, Ohio. This feeder has an auger type feed mechanism. Fluidized bed feeders and barrel roll feeders with an angular slit may also be used.

In the process of the present invention, the feeders may be pressurized with a gas selected from the group consisting of helium, nitrogen, other inert gases, and mixtures thereof. Feeder pressures are usually above the main gas or head pressures, which pressures are usually in the range of from 250 psi to 500 psi, depending on the powdered material composition. The main gas is preferably heated so that gas temperatures are in the range of from 600 degrees Fahrenheit to 1200 degrees Fahrenheit. If desired, the main gas may be heated as high as approximately 1250 degrees Fahrenheit depending on the material being deposited. The gas may be heated to keep it from rapidly cooling and freezing once it expands past the throat of nozzle 20. The net effect is a surface temperature on the part being repaired of about 115 degrees Fahrenheit during deposition. Any suitable means known in the art may be used to heat the gas.

To deposit the metal material, the nozzle 20 may pass over the surface 24 of the part 10 being repaired more than once. The number of passes required is a function of the thickness of the metal material to be applied to the surface 24. The method of the present invention is capable of forming a deposit having any desired thickness. If one wants to form a thick layer, the spray gun 22 may be held stationary and be used to form a deposit on the surface 24 that is several inches high. When building a deposit layer of metal material, it is desirable to limit the thickness per pass in order to avoid a quick build up of residual stresses and unwanted debonding between deposit layers.

The main gas that is used to deposit the particles of the metal material onto the surface 24 may be passed through the nozzle 20 via inlet 30 and/or inlet 32 at a flow rate of from 0.001 SCFM to 50 SCFM, preferably in the range of from 15 SCFM to 35 SCFM. The foregoing pressures are preferred if helium is used as the main gas. If nitrogen is used by itself or in combination with helium as the main gas, the nitrogen gas may be passed through the nozzle 20 at a flow rate of from 0.001 SCFM to 30 SCFM, preferably from 4 to 30 SCFM.

The main gas temperature may be in the range of from 600 degrees Fahrenheit to 1200 degrees Fahrenheit, preferably from 700 degrees Fahrenheit to 800 degrees Fahrenheit, and most preferably from 725 degrees Fahrenheit to 775 degrees Fahrenheit.

The pressure of the spray gun 22 may be in the range of from 200 psi to 350 psi, preferably from 200 psi to 250 psi. The powdered metal material is preferably fed from a hopper, which is under a pressure in the range of from 200 psi to 300 psi, preferably from 225 psi to 275 psi, to the spray gun 22 via line 34 at a rate in the range of from 10 grams/min to 100 grams/min, preferably from 15 grams/min to 50 grams/min.

The powdered metal material is preferably fed to the spray gun 22 using a carrier gas. The carrier gas may be introduced via inlet 30 and/or inlet 32 at a flow rate of from 0.001 SCFM to 50 SCFM, preferably from 8 SCFM to 15 SCFM. The foregoing flow rate is useful if helium is used as the carrier gas. If nitrogen by itself or mixed with helium is used as the carrier gas, a flow rate of from 0.001 SCFM to 30 SCFM, preferably from 4 to 10 SCFM, may be used.

The spray nozzle 20 is preferably held at a distance from the surface 24. This distance is known as the spray distance. Preferably, the spray distance is in the range of from 10 mm. to 50 mm.

The velocity of the powdered metal material particles leaving the spray nozzle 20 may be in the range of from 825 m/s to 1400 m/s. preferably from 850 m/s to 1200 m/s.

The deposit thickness per pass may be in the range of from 0.001 inches to 0.030 inches.

Cold spray offers many advantages over other metallization processes. Since the metal powders used for the metal material are not heated to high temperatures, no oxidation, decomposition, or other degradation of the feedstock material occurs. Powder oxidation during deposition is also controlled since the particles are contained within the accelerating gas stream. Cold spray also retains the microstructure of the feedstock. Still further, because the feedstock is not melted, cold spray offers the ability to deposit materials that cannot be sprayed conventionally due to the formation of brittle intermetallics or a propensity to crack upon cooling or during subsequent heat treatments.

Cold spray, because it is a solid state process, does not heat up the substrate appreciably. As a result, any resulting distortion is minimized. Cold spray induces compressive surface residual stresses, so the driving force for strain age cracking is eliminated.

It is apparent that there has been provided in accordance with the present invention a vaccum cold spray process which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A method for depositing a metallic material onto a substrate comprises the steps of:
placing the substrate in a vacuum chamber;
inserting a spray gun nozzle into a port of said vacuum chamber; and
depositing a powdered metallic material onto a surface of said substrate without melting said powdered metal material.

2. A method according to claim 1, wherein said depositing step comprises accelerating particles of said powdered metal materials within said vacuum chamber to a velocity so that upon impact the particles plastically deform and bond to a surface of said substrate.

3. A method according to claim 1, wherein said depositing step comprises providing said powdered metallic material in particle form having a particle size in the range of from 5 microns to 50 microns.

4. A method according to claim 3, wherein said depositing step further comprises accelerating said particles to a speed in the range of from 825 m/s to 1400 m/s.

5. The method according to claim 4, wherein said accelerating step comprises accelerating said particles to a speed in the range of from 850 m/s to 1200 m/s.

6. The method according to claim 4, further comprising feeding said metallic material powder to said spray gun nozzle at a feed rate of from 10 grams/min to 100 grams/min at a pressure in the range of from 200 psi to 300 psi using a carrier gas selected from the group consisting of helium, nitrogen, and mixtures thereof.

7. The method according to claim 6, wherein said feeding step comprises feeding said metal powder to said spray gun nozzle at a feed rate from 15 grams/min to 50 grams/min.

8. The method according to claim 6, wherein said carrier gas comprises helium and said feeding step comprises feeding said helium to said spray gun nozzle at a flow rate of from 0.001 SCFM to 50 SCFM.

9. The method according to claim 8, wherein said feeding step comprises feeding said helium to said spray gun nozzle at a flow rate of from 8 to 15 SCFM.

10. The method according to claim 6, wherein said carrier gas comprises nitrogen and said feeding step comprises feeding said nitrogen to said spray gun nozzle at a flow rate of from 0.001 SCFM to 30 SCFM.

11. The method according to claim 10, wherein said feeding step comprises feeding said nitrogen to said spray gun nozzle at a flow rate of from 4 to 10 SCFM.

12. The method according to claim 6, wherein said depositing step further comprises passing said metallic material powder particles through said spray gun nozzle using a main gas selected from the group consisting of helium, nitrogen, and mixtures thereof at a main gas temperature in the range of from 600 degrees Fahrenheit to 1200 degrees Fahrenheit and at a spray pressure in the range of from 200 psi to 350 psi.

13. The method according to claim 12, wherein said passing step comprises passing said metal powder particles through said spray gun nozzle at a main gas temperature in the range of 700 degrees Fahrenheit to 800 degrees Fahrenheit at a spray pressure in the range of from 250 psi to 350 psi.

14. The method according to claim 12, wherein said main gas temperature is in the range of from 725 degrees Fahrenheit to 775 degrees Fahrenheit.

15. The method according to claim 12, wherein said main gas comprises helium and said passing step comprises feeding said helium to said spray gun nozzle at a rate in the range of from 0.001 SCFM to 50 SCFM.

16. The method according to claim 15, wherein said helium feeding step comprises feeding said helium at a rate of from 15 to 35 SCFM.

17. The method according to claim 12, wherein said main gas comprises nitrogen and said passing step comprises feeding said nitrogen to said spray gun nozzle at a rate in the range of from 0.001 SCFM to 30 SCFM.

18. The method according to claim 17, wherein said nitrogen feeding step comprises feeding said nitrogen to said spray gun nozzle at a rate in the range of from 4 to 8 SCFM.

19. The method according to claim 6, further comprising maintaining said spray gun nozzle at a distance from 10 mm to 50 mm from said substrate.

20. A system for depositing a metallic material onto a substrate comprising:
a vacuum chamber in which the substrate is positioned;
means for depositing a powdered metallic material onto a surface of the substrate without melting the powdered metallic material; and
said depositing means including a spray gun nozzle positioned within a port of the vacuum chamber.

21. A system according to claim 20, wherein said depositing means further comprises means for accelerating particles of said powdered metallic material to a velocity so that upon impact the particles plastically deform and bond to said surface of said substrate.

22. A system according to claim 21, further comprising means for providing a gas selected from the group consisting of nitrogen, helium, and mixtures thereof to said spray gun nozzle to accelerate particles of said metallic material.
